(19) United States
(12) Patent Application Publication
(10) Pub. No.: US 2025/0212862 A1
(43) Pub. Date: Jul. 3, 2025

(54) MOSQUITO-TRAPPING LIGHT SOURCE MODULE, ELECTRIC MOSQUITO SWATTER AND MOSQUITO KILLER

(71) Applicant: ZHONGSHAN HUAYUAN OPTOELECTRONICS TECH CO., LTD, Zhongshan City (CN)

(72) Inventors: Ying ZHANG, Zhongshan City (CN); lizao ZHANG, Zhongshan City (CN)

(73) Assignee: ZHONGSHAN HUAYUAN OPTOELECTRONICS TECH CO., LTD, Zhongshan City (CN)

(21) Appl. No.: 18/668,643

(22) Filed: May 20, 2024

(30) Foreign Application Priority Data
Dec. 28, 2023 (CN) 2023236194470

(51) Int. Cl. A01M 1/04; A01M 1/22; A01M 3/02

(52) U.S. Cl. CPC A01M 1/04; A01M 3/025; A01M 1/223

(57) ABSTRACT

A mosquito-trapping light source module, an electric mosquito swatter and a mosquito killer are disclosed, the mosquito-trapping light source module includes two or more LED chips with different wavelengths, the wavelengths of the LED chips range from 360 nm to 400 nm. By configuring the two or more LED chips with different wavelengths, the mosquito-trapping light source module has a wide spectral range, so that mosquitoes in different types and regions are trapped, the mosquitoes are trapped under different environmental conditions, and a good mosquito-trapping effect is achieved. By setting the wavelengths of the LED chips to range from 360 nm to 400 nm, an appropriate wavelength range is selected according to currently common mosquitoes and actual environmental conditions of use to reduce power waste and maintain a good mosquito-trapping effect.

### CROSS-REFERENCE TO RELATED APPLICATIONS

This application claims priority to Chinese patent application No. 202323619447.0 filed Dec. 28, 2023. The content of the application is incorporated herein by reference in their entirety.

### TECHNICAL FIELD

The present disclosure relates to the technical field of mosquito-trapping devices, and in particular to a mosquito-trapping light source module, an electric mosquito swatter and a mosquito killer.

### BACKGROUND

An electric mosquito swatter, an indoor mosquito killer, an outdoor mosquito killer, and the like all set up a mosquito-trapping light source to trap mosquitoes to fly close to an electric grid by utilizing the phototaxis of mosquitoes, and kill the mosquitoes by utilizing high-voltage electricity. A traditional mosquito-trapping light source is a Ultra Violet (UV) lamp tube, and the UV lamp tube has a wide wavelength range, so that a certain mosquito trapping effect is achieved. However, the wavelength range of the UV lamp tube is much larger than an actual mosquito-trapping wavelength range, therefore the UV lamp tube has great power waste in actual use.

At present, with the development of LED technology, LED lamp beads with the UV light source wavelength are gradually used to replace the traditional UV lamp tube, the LED lamp beads are generally set to have a small-range or fixed wavelength, which makes a spectrum of a mosquito-trapping light source made of the UVLED lamp beads relatively simple. However, the phototaxis of mosquitoes is affected by light intensity and wavelength, trapping wavelengths for mosquitoes in different regions and different types under different environmental conditions such as temperature and humidity are different, therefore the current mosquito-trapping light source made of the UVLED lamp beads has a poor mosquito-trapping effect, and the wavelength setting is unreasonable.

### SUMMARY

The present disclosure aims to solve at least one of the technical problems in the prior art. Therefore, the present disclosure provides a mosquito-trapping light source module with a good mosquito-trapping effect.

The present disclosure further provides an electric mosquito swatter.

The present disclosure further provides a mosquito killer.

A mosquito-trapping light source module according to an embodiment in a first aspect of the present disclosure includes two or more LED chips with different wavelengths, where wavelengths of the LED chips range from 360 nm to 400 nm.

The mosquito-trapping light source module according to the embodiment of the present disclosure has at least the following beneficial effects: by configuring the two or more LED chips with different wavelengths, the mosquito-trapping light source module has a wide spectral range, so that mosquitoes in different types and regions are trapped, the mosquitoes are trapped under different environmental conditions, and a good mosquito-trapping effect is achieved. By setting the wavelengths of the LED chips to range from 360 nm to 400 nm, an appropriate wavelength range is selected according to currently common mosquitoes and actual environmental conditions of use to reduce power waste and maintain a good mosquito-trapping effect.

According to some embodiments of the present disclosure, each of the LED chips is provided with an independent power control module.

According to some embodiments of the present disclosure, the LED chips are connected through a parallel circuit, and the power control module is connected to a corresponding LED chip in series.

According to some embodiments of the present disclosure, two or more LED chips with the same wavelength are connected to form an isospectral light source group, and the isospectral light source group is provided with an independent power control module.

According to some embodiments of the present disclosure, the two or more LED chips with the same wavelength are connected to form the isospectral light source group, two or more isospectral light source groups are arranged and connected through a parallel circuit, and the power control module is connected to the isospectral light source group in series.

According to some embodiments of the present disclosure, the power control module is an adjustable power control module.

According to some embodiments of the present disclosure, the mosquito-trapping light source module includes but is not limited to a lamp tube, a plane light source or a lamp bulb.

An electric mosquito swatter according to an embodiment in a second aspect of the present disclosure includes an electric mosquito swatter housing, a mosquito swatter electric grid and the mosquito-trapping light source module according to any one of the embodiments in the first aspect of the present disclosure, wherein the mosquito swatter electric grid is arranged in the electric mosquito swatter housing, and the mosquito-trapping light source module is arranged in the electric mosquito swatter housing and located at an inner side of the mosquito swatter electric grid.

The electric mosquito swatter according to the embodiment of the present disclosure has at least the following beneficial effects: the electric mosquito swatter can be actively waved to kill the mosquitoes or trap the mosquitoes to fly close to kill the mosquitoes, and by configuring the LED chips with different wavelengths, good mosquito-trapping and mosquito-killing effects are achieved.

According to some embodiments of the present disclosure, the electric mosquito swatter further includes a light source bracket arranged in the electric mosquito swatter housing, the mosquito-trapping light source module is arranged on the light source bracket, the light source bracket includes at least two bifurcated portions, and LED chips on the at least two bifurcated portions have different wavelengths.

According to some embodiments of the present disclosure, the electric mosquito swatter further includes a base, and the base is provided with a slot into which a lower portion of the electric mosquito swatter housing is inserted.

A mosquito killer according to an embodiment in a third aspect of the present disclosure includes the mosquito-trapping light source module according to any one of the embodiments in the first aspect of the present disclosure.

The mosquito killer according to the embodiment of the present disclosure has at least the following beneficial effects: by trapping the mosquitoes to fly close to the electric grid through the mosquito-trapping light source module, the mosquito-killing effect is achieved. In addition, the mosquito-trapping light source module is the UVLED chips with different wavelengths, such that the advantages of good mosquito-trapping effect and strong applicability are achieved.

### BRIEF DESCRIPTION OF THE DRAWINGS

The above and/or additional aspects and advantages of the present disclosure will be apparent and easily understood from the descriptions of embodiments with reference to the following drawings, wherein:

FIG. 1 is a first schematic circuit diagram of a mosquito-trapping light source module according to an embodiment of the present disclosure;

FIG. 2 is a second schematic circuit diagram of the mosquito-trapping light source module according to the embodiment of the present disclosure;

FIG. 3 is a first schematic structural diagram when the mosquito-trapping light source module according to the embodiment of the present disclosure is a lamp tube;

FIG. 4 is a second schematic structural diagram when the mosquito-trapping light source module according to the embodiment of the present disclosure is the lamp tube;

FIG. 5 is a third schematic structural diagram when the mosquito-trapping light source module according to the embodiment of the present disclosure is the lamp tube;

FIG. 6 is a fourth schematic structural diagram when the mosquito-trapping light source module according to the embodiment of the present disclosure is the lamp tube;

FIG. 7 is a first schematic structural diagram when the mosquito-trapping light source module according to the embodiment of the present disclosure is a plane lamp;

FIG. 8 is a second schematic structural diagram when the mosquito-trapping light source module according to the embodiment of the present disclosure is the plane lamp;

FIG. 9 is a first schematic structural diagram when the mosquito-trapping light source module according to the embodiment of the present disclosure is a lamp bulb;

FIG. 10 is a second schematic structural diagram when the mosquito-trapping light source module according to the embodiment of the present disclosure is the lamp bulb;

FIG. 11 is a schematic structural diagram of an electric mosquito swatter according to the embodiment of the present disclosure;

FIG. 12 is an exploded view of the electric mosquito swatter according to the embodiment of the present disclosure;

FIG. 13 is a schematic structural diagram of a first electric mosquito swatter according to the embodiment of the present disclosure;

FIG. 14 is an exploded view of the first electric mosquito swatter according to the embodiment of the present disclosure; and

FIG. 15 is a schematic structural diagram of a second electric mosquito swatter according to the embodiment of the present disclosure.

### REFERENCE NUMERALS

100 refers to electric mosquito swatter housing, 200 refers to mosquito swatter electric grid, 300 refers to light source bracket, 400 refers to base, and 500 refers to power control module.

### DETAILED DESCRIPTION

Embodiments of the present disclosure are described in detail hereinafter, and examples of the embodiments are shown in the drawings, wherein the same or similar reference numerals throughout the drawings denote the same or similar elements or elements having the same or similar functions. The embodiments described hereinafter with reference to the drawings are exemplary, and are only used to explain the present disclosure, but should not be understood as limiting the present disclosure.

In the description of the present disclosure, it should be understood that the orientations or positional relationships indicated by the terms such as “upper”, “lower”, “front”, “rear”, “left”, “right” and the like, refer to the orientations or positional relationships shown in the drawings, which are only intended to facilitate describing the present disclosure and simplifying the description, and do not indicate or imply that the indicated devices or elements must have a specific orientation, be constructed and operated in a specific orientation, and therefore cannot be understood as a limitation of the present disclosure.

In the description of the present disclosure, the term “first” or “second” is only for the purpose of distinguishing technical features, and shall not be understood as indicating or implying relative importance or implying the number of indicated technical features or implying the order of indicated technical features.

In the description of the present disclosure, the terms “arrangement”, “installation”, “connection”, and the like should be understood in broad sense unless otherwise specified and defined. The specific meaning of the above terms in the present disclosure can be reasonably determined according to specific contents of the technical solutions by those skilled in the art. In the existing technology, a spectrum of a mosquito-trapping light source made of UVLED lamp beads is relatively simple, and the phototaxis of mosquitoes is affected by light intensity and wavelength, trapping wavelengths for mosquitoes in different regions and different types under different environmental conditions such as temperature and humidity are different, so that the mosquito-trapping light source made of the UVLED lamp beads has a poor mosquito-trapping effect.

A mosquito-trapping light source module according to an embodiment of the present disclosure is described hereinafter with reference to FIG. 1.

As shown in FIG. 1, the mosquito-trapping light source module according to the embodiment of the present disclosure includes two or more LED chips with different wavelengths wherein the wavelengths of the LED chips range from 360 nm to 400 nm.

By configuring the two or more LED chips with different wavelengths, the mosquito-trapping light source module has a wide spectral range, so that mosquitoes in different types and regions are trapped, the mosquitoes are trapped under different environmental conditions, and a good mosquito-trapping effect is achieved. By setting the wavelengths of the LED chips to range from 360 nm to 400 nm, an appropriate wavelength range is selected according to currently common mosquitoes and actual environmental conditions of use to reduce power waste and maintain a good mosquito-trapping effect.

Specifically, the mosquito-trapping light source module can be a lamp strip, a lamp tube, a COB integrated light source, and the like. A number of the LED chips can be selected as required, such as two, three or more, and wavelength specifications of the LED chips can also be selected as two, three or more, so that the mosquito-trapping light source module has a good mosquito-trapping effect.

According to some embodiments of the present disclosure, each LED chip is provided with an independent power control module 500 to independently control light intensity of each LED chip, so as to achieve the good mosquito-trapping effect.

Specifically, the mosquito-trapping effect of the light source can also be affected by the light intensity, and by configuring the independent power control module 500 for the LED chips with different wavelengths, the light intensity of the LED chips with different wavelengths can be adjusted to achieve the good mosquito-trapping effect and reduce power waste.

As shown in FIG. 1, in some embodiments of the present disclosure, the LED chips are connected through a parallel circuit, and the power control module 500 is connected to the corresponding LED chip in series to achieve an effect of controlling power of the LED chips.

Specifically, the power control module 500 can be a resistor, a semiconductor switch tube, and the like, and the power control of the LED chips is realized by controlling a voltage or a current.

It should be noted that, in some embodiments of the present disclosure, the LED chips are connected through a series circuit, and the power control module 500 is connected in parallel with the corresponding LED chip, which can also achieve the effect of controlling power of the LED chips.

It should be noted that, in some embodiments of the present disclosure, two or more LED chips with the same wavelength are connected to form an isospectral light source group, and the isospectral light source group is provided with an independent power control module 500, which can realize light adjustment of a plurality of LED chips with the same wavelength.

Specifically, at least one LED chip (such as one, two or more LED chips) with the same wavelength is connected (in series or in parallel) to form the isospectral light source group with the same spectrum, and the independent power control module 500 is configured to uniformly control the LED chips with the same spectrum.

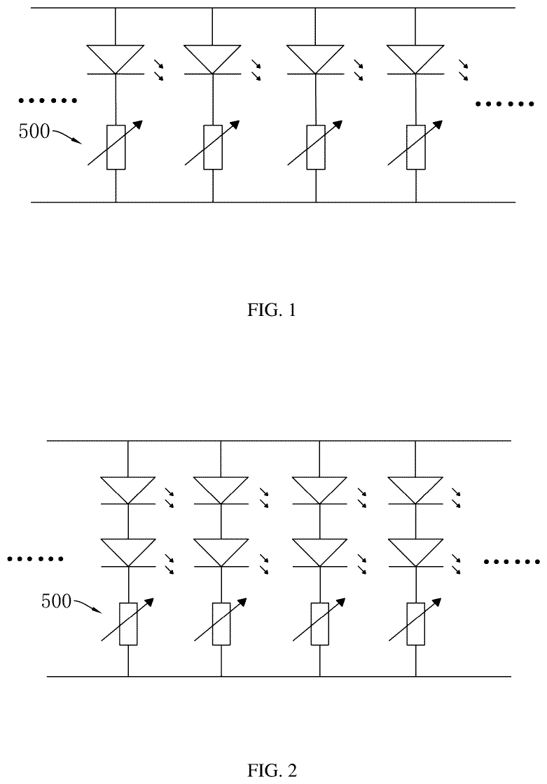

As shown in FIG. 2, in some embodiments of the present disclosure, the two or more LED chips with the same wavelength are connected to form the isospectral light source group, and two or more isospectral light source groups are arranged and connected through a parallel circuit, and the power control module 500 is connected to the isospectral light source group in series to achieve the purpose of controlling power of the isospectral light source group.

According to some embodiments of the present disclosure, the power control module 500 is an adjustable power control module, such as an adjustable resistor and an adjustable semiconductor switch tube circuit lamp, so as to adjust the power of the LED chips according to an actual use situation.

As shown in FIG. 1 and FIG. 2, in some embodiments of the present disclosure, the power control module 500 is the adjustable resistor.

It should be noted that, in some embodiments of the present disclosure, the power control module 500 can be connected to a control chip to achieve a light adjustment function.

It should be noted that, in some embodiments of the present disclosure, the mosquito-trapping light source module is a single light source assembled by a plurality of LED chips. That is, the plurality of LED chips are integrated into a small area to form an integrated light source which has high brightness and includes the LED chips with different wavelengths, such as a COB light source, so as to meet a miniaturized mounting requirement of the mosquito-trapping light source module.

It should be noted that, in some embodiments of the present disclosure, the mosquito-trapping light source module includes but is not limited to a lamp tube, a plane light source or a lamp bulb to meet use requirements of different mosquito killers.

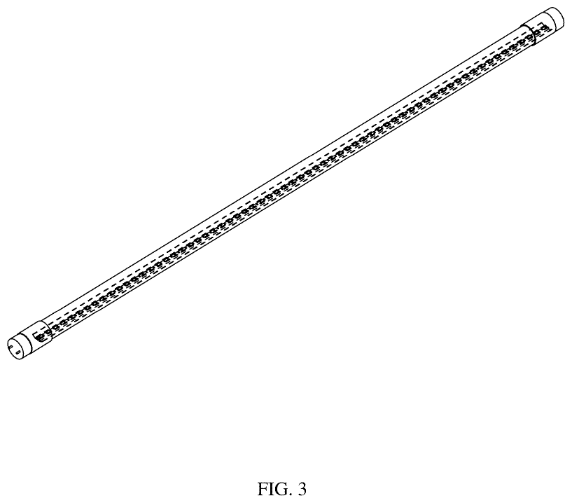

As shown in FIG. 3, the mosquito-trapping light source module is a single-side light-emitting lamp tube, with a light-emitting angle adjustable as required, such as 120°, 150°, 180°, and the like, and two ends of the lamp tube are in an inserted structure to cooperate with a lamp base, so that the lamp tube can cooperate with an existing lamp-tube mosquito killer.

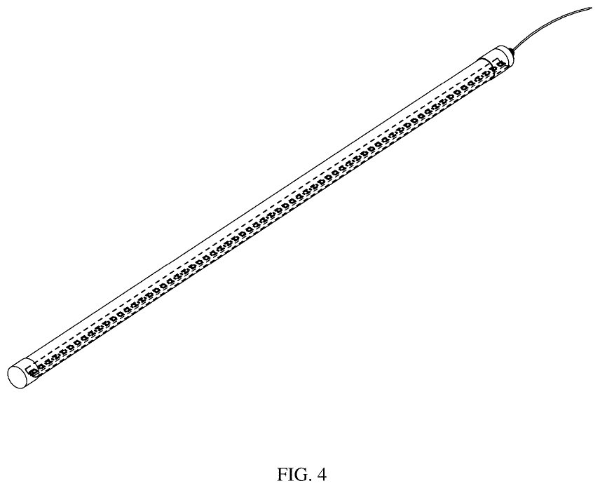

As shown in FIG. 4, the mosquito-trapping light source module is the single-side light-emitting lamp tube, with the light-emitting angle adjustable as required, such as 120°, 150°, 180°, and the like, at least one end of the lamp tube is provided with an external power cord, and after the power cord is electrified, the lamp tube can be directly used to trap mosquitoes, thus being more flexible and convenient to use.

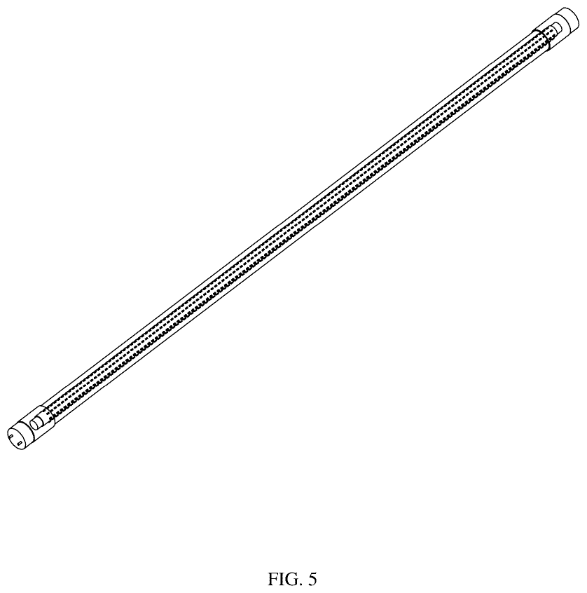

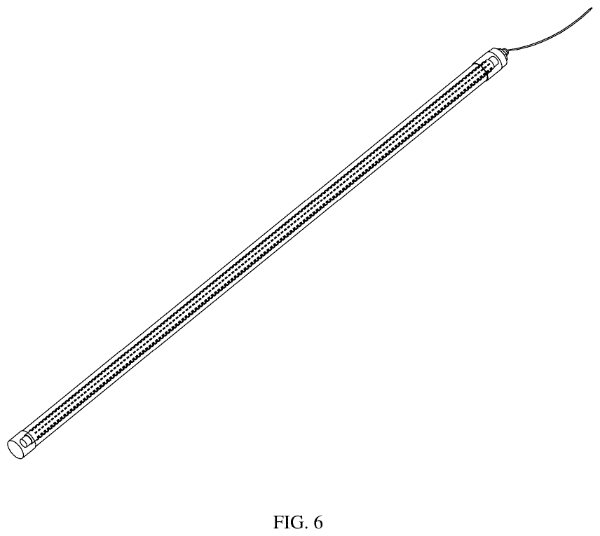

As shown in FIG. 5, the mosquito-trapping light source module is a 360° light-emitting lamp tube, a lamp post with annularly distributed LED chips is arranged inside the lamp tube to realize 360° light emission, and two ends of the lamp tube are in an inserted structure to cooperate with the lamp base, so that the lamp tube can cooperate with the existing lamp-tube mosquito killer.

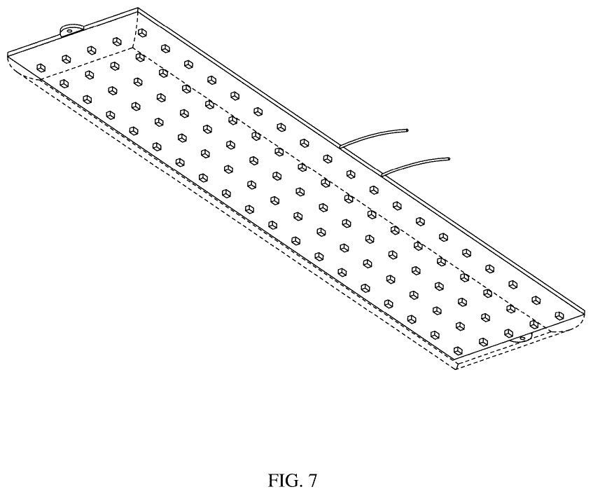

As shown in FIG. 6, the mosquito-trapping light source module is the 360° light-emitting lamp tube, the lamp post with annularly distributed LED chips is arranged inside the lamp tube to realize 360° light emission. At least one end of the lamp tube is provided with the external power cord, and after the power cord is electrified, the lamp tube can be directly used to trap mosquitoes, thereby being more flexible and convenient to use.

As shown in FIG. 7, the mosquito-trapping light source module is the plane light source, and is specifically a single-side light-emitting panel lamp, and the LED chips are arranged on a plane substrate to realize plane light emission.

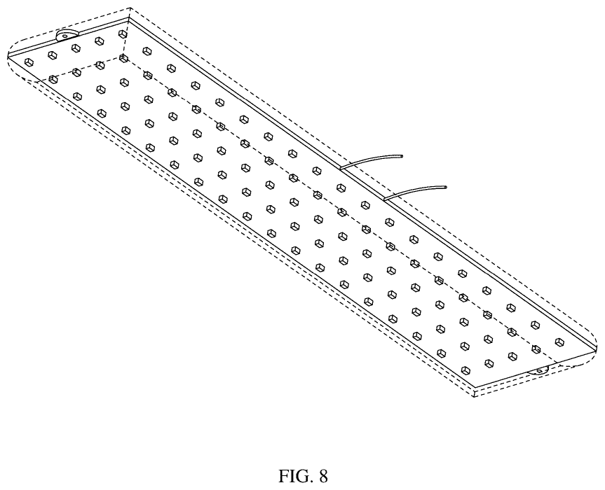

As shown in FIG. 8, the mosquito-trapping light source module is the plane light source, and is specifically a double-side light-emitting panel lamp, and the LED chips are arranged on front and back sides of one plane substrate to realize double-sides light emission.

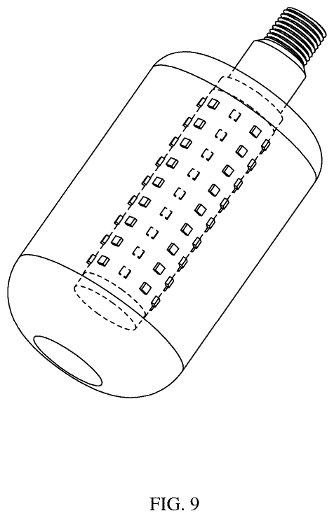

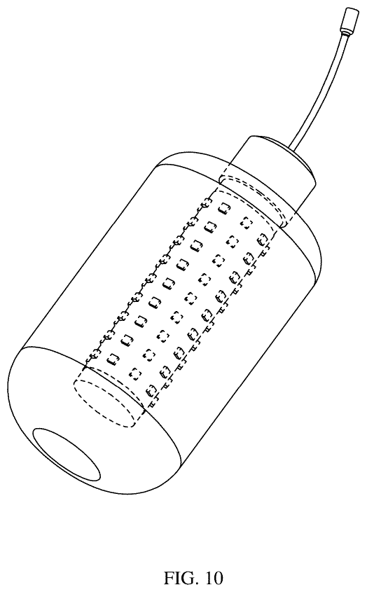

As shown in FIG. 9, the mosquito-trapping light source module is the lamp bulb, the lamp post with annularly distributed LED chips is arranged inside the lamp bulb to realize 360° light emission, and one end of the lamp bulb is provided with a connector (such as a screw connector, a clamping connector, and the like) to cooperate with an existing lamp base, so that the lamp bulb can be used for replacing a lamp bulb of the traditional mosquito killer.

As shown in FIG. 9, the mosquito-trapping light source module is the lamp bulb, the lamp post with annularly distributed LED chips is arranged inside the lamp bulb to realize 360° light emission, one end of the lamp bulb is provided with a power cord. After the power cord is electrified, the lamp tube can be directly used to trap mosquitoes, thus being more flexible and convenient to use.

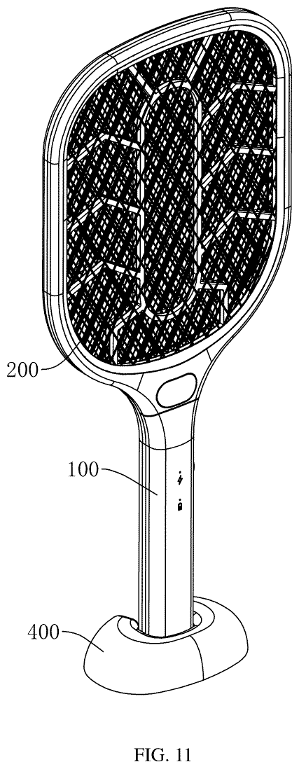

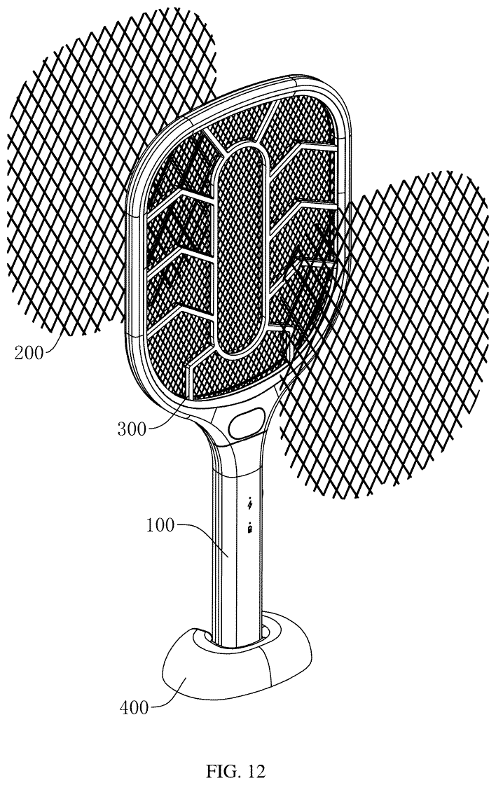

With reference to FIG. 11 and FIG. 12, an electric mosquito swatter according to an embodiment in a second aspect of the present disclosure includes an electric mosquito swatter housing 100, a mosquito swatter electric grid 200 and the mosquito-trapping light source module according to any one of the embodiments in the first aspect of the present disclosure, wherein the mosquito swatter electric grid 200 is arranged in the electric mosquito swatter housing 100, and the mosquito-trapping light source module is arranged in the electric mosquito swatter housing 100 and located at an inner side of the mosquito swatter electric grid 200.

The electric mosquito swatter can be actively waved to kill the mosquitoes or trap the mosquitoes to fly close to kill the mosquitoes, and by configuring the LED chips with different wavelengths, good mosquito-trapping and mosquito-killing effects are achieved.

As shown in FIG. 12, in some embodiments of the present disclosure, the electric mosquito swatter further includes a light source bracket 300 arranged in the electric mosquito swatter housing 100, the mosquito-trapping light source module is arranged on the light source bracket 300, the light source bracket 300 includes at least two bifurcated portions, and LED chips on the at least two bifurcated portions have different wavelengths, so that at least two different bifurcated portions can emit mosquito-trapping light with different wavelengths, thus achieving the good mosquito-trapping effect.

Specifically, as shown in FIG. 12, the light source bracket 300 is provided with a plurality of bifurcated portion, the mosquito swatter electric grid 200 is adapted. The mosquito-trapping light source module is a lamp strip or a lamp string, which is arranged along the bifurcated portions, so that light can be emitted to all positions of the mosquito swatter electric grid 200, thus achieving the good mosquito-killing effect.

It should be noted that, in some embodiments of the present disclosure, the electric mosquito swatter housing 100 is provided with an electric grid mounting region, and the mosquito-trapping light source module is arranged on an edge of the electric grid mounting region, so as to increase light source brightness of an edge of the mosquito swatter electric grid 200, and increase a setting number of the LED chips, thus achieving the good mosquito-trapping effect.

As shown in FIG. 11, in some embodiments of the present disclosure, the electric mosquito swatter further includes a base 400, and the base 400 is provided with a slot into which a lower portion of the electric mosquito swatter housing 100 is inserted, so that the electric mosquito swatter can be placed vertically for actively trapping and killing mosquitoes.

It should be noted that, in some embodiments of the present disclosure, the electric mosquito swatter further includes a battery pack arranged in the electric mosquito swatter housing 100, and the battery pack can supply power to the mosquito-trapping light source module and the mosquito swatter electric grid 200.

Specifically, the electric mosquito swatter is provided with a charging module, the charging module is connected to the battery pack to charge the battery pack, the charging module is provided with a charging interface, and the charging interface can be a micro-usb interface, a type-c interface, and the like.

It should be noted that, in some embodiments of the present disclosure, the base 400 is a charging base, which can be connected with the charging interface or supply power to the mosquito-trapping light source module and the mosquito swatter electric grid 200, thus being convenient to use.

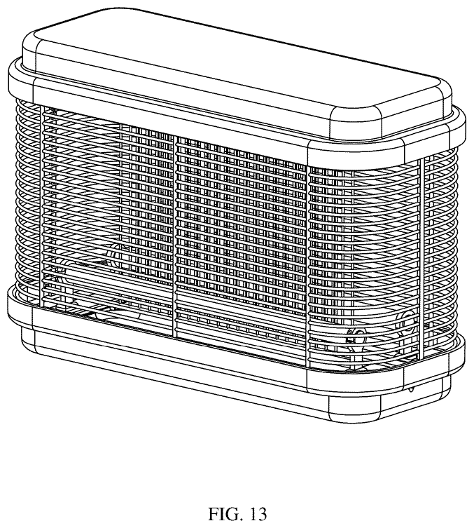

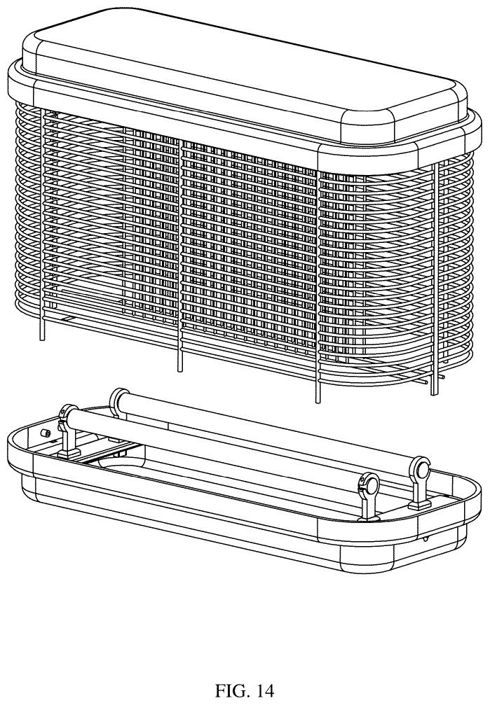

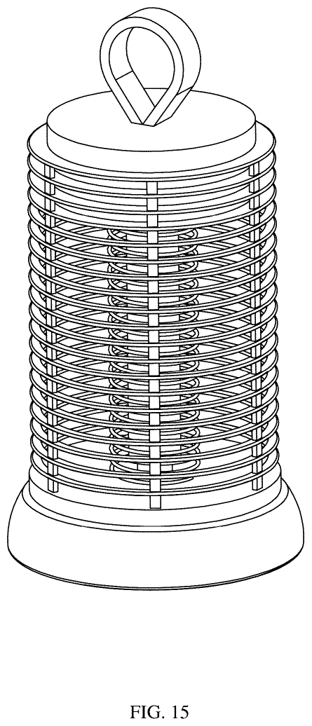

With reference to FIG. 13, FIG. 14 and FIG. 15, a mosquito killer according to an embodiment in a third aspect of the present disclosure includes the mosquito-trapping light source module according to any one of the above embodiments in the first aspect of the present disclosure. Specifically, the mosquito killer includes the mosquito-trapping light source module and the electric grid, by trapping the mosquitoes to fly close to the electric grid through the mosquito-trapping light source module, the mosquito-killing effect is achieved. In addition, the mosquito-trapping light source module is the UVLED chips with different wavelengths, such that the advantages of good mosquito-trapping effect and strong applicability are achieved.

It should be noted that, in some embodiments of the present disclosure, the mosquito-trapping light source module is the lamp tube, which is detachably mounted on the mosquito killer.

It should be noted that, in some embodiments of the present disclosure, the mosquito killer can be an outdoor mosquito killer or an indoor mosquito killer.

Certainly, the present disclosure is not limited to the above embodiments. Those skilled in the art can further make various equivalent modifications or substitutions without violating the gist of the present disclosure, and these equivalent modifications or substitutions are all included in the scope defined by the claims of the present disclosure.

What is claimed is:

1. A mosquito-trapping light source module, comprising:
two or more LED chips with different wavelengths, wherein wavelengths of the LED chips range from 360 nm to 400 nm.

2. The mosquito-trapping light source module according to claim 1, wherein,
each of the LED chips is provided with an independent power control module.

3. The mosquito-trapping light source module according to claim 2, wherein:
the LED chips are connected through a parallel circuit, and the power control module is connected to a corresponding LED chip in series.

4. The mosquito-trapping light source module according to claim 1, wherein:
the two or more LED chips with the same wavelength are connected to form an isospectral light source group, and wherein the isospectral light source group is provided with an independent power control module.

5. The mosquito-trapping light source module according to claim 4, wherein:
the two or more LED chips with the same wavelength are connected to form the isospectral light source group, two or more isospectral light source groups are arranged and connected through a parallel circuit, and the power control module is connected to the isospectral light source group in series.

6. The mosquito-trapping light source module according to claim 2, wherein:
the power control module is an adjustable power control module.

7. The mosquito-trapping light source module according to claim 1, wherein:
the mosquito-trapping light source module comprises but is not limited to a lamp tube, a plane light source or a lamp bulb.

8. An electric mosquito swatter, comprising:
an electric mosquito swatter housing;
a mosquito swatter electric grid, wherein the mosquito swatter electric grid is arranged in the electric mosquito swatter housing; and
a mosquito-trapping light source module according to claim 1, wherein the mosquito-trapping light source module is arranged in the electric mosquito swatter housing and located at an inner side of the mosquito swatter electric grid.

9. The electric mosquito swatter according to claim 8, further comprising a light source bracket arranged in the electric mosquito swatter housing, the mosquito-trapping light source module is arranged on the light source bracket, the light source bracket comprises at least two bifurcated portions, and LED chips on the at least two bifurcated portions have different wavelengths.

10. A mosquito killer, comprising a mosquito-trapping light source module according to claim 1.
